(19) United States
(12) Patent Application Publication
(10) Pub. No.: US 2023/0023526 A1
(43) Pub. Date: Jan. 26, 2023

(54) System and Method for Matching Job Services Using Deep Neural Networks

(71) Applicant: Payscale, Seattle, WA (US)

(72) Inventors: Sean HARRINGTON, Kirkland, WA (US); Adrien TROUILLAUD, Seattle, WA (US); Nicholas MCCLURE, Seattle, WA (US); Casey HERRON, Seattle, WA (US); Neal DAWSON-ELLI, Redmond, WA (US); Galen SCOVELL, Vancouver, WA (US)

(73) Assignee: Payscale, Seattle, WA (US)

(21) Appl. No.: 17/870,152

(22) Filed: Jul. 21, 2022

Related U.S. Application Data
(63) Continuation of application No. 63/224,010, filed on Jul. 21, 2021.

(51) Int. Cl. G06Q 10/10

(52) U.S. Cl. CPC G06Q 10/1053

(57) ABSTRACT

An automated business method for matching education, salary and other employment-related data is disclosed. In one example embodiment, the automated business method includes integrating of two or more neural networks to match job-related services.

### CROSS-REFERENCE TO RELATED APPLICATIONS

The present application claims benefit of Provisional Application No. 63/224,010, filed Jul. 21, 2021, the entire contents of which is incorporated herein by reference.

### FIELD

The present invention relates generally to business and automated methods for matching education, salary and other employment-related data, and in a particular though non-limiting embodiment to a system and method for matching job-services using a plurality of deep neural networks.

### SUMMARY

The system and method for matching job services disclosed herein allows a user to match any job title to one or more of a plurality of defined job families (or “rollups”).

In one detailed embodiment, other “compensable factors,” including but not limited to years of experience, education, management role, the relevant skills & certifications for a given input title and/or an optional job description are recommended to the user.

In another example embodiment, a method of use comprises accessing, transforming, and evaluating several different machine-learning models, and using historical job matching data available the user to get the best possible match.

In one embodiment, a match to a job rollup library is made in order to receive a pay estimate from a crowd-sourced compensation model. Ordinarily skilled artisans will readily appreciate, however, there are several challenges when attempting to arrive at the most accurate match. One such challenge is inconsistent, inaccurate and/or incomprehensible job titles entered by a user.

For example, job titles from Human Resources Information Systems (or “HRIS systems”) often contain abbreviations, acronyms and synonyms.

Examples of actual job titles mapped to job rollups prior to the invention include:
“PHYS THRP” for “Physical Therapist”
“SR. WHARF SUPERINTENDENT” for “Cargo Services Supervisor”
“ERS & S Analyst” for “Sustainability Consulting Analyst”

As can be readily discerned, a dynamically transformable, standardized matching method is not possible given such a large set of possible matches. For example, one popular matching service has over ten-thousand unique job rollups to which incoming job titles are matched.

In one example embodiment, rather than using hand-coded rules or heuristics, machine-learning algorithms evaluate, transform and match millions of examples of job matches performed by human experts, optimally including users and professional benchmarking teams. The various job titles, then, essentially serve as a unique domain within natural language processing, and the system learns the semantic relationships between the job title words.

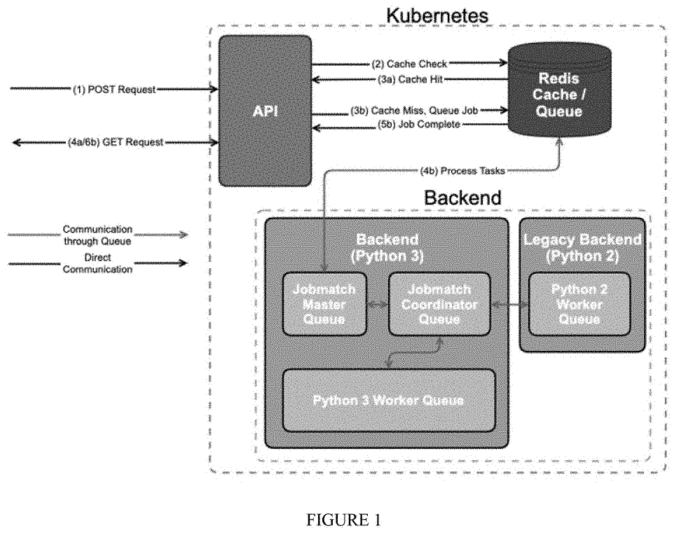

As illustrated in the example embodiment depicted in FIG. 1, the system comprises a plurality (two or more) of deep neural networks.

In the depicted embodiment, a first deep neural network comprises a Word-Level Convolutional Neural Network. Word-level convolutional neural networks learn custom word embeddings and semantic relationships between job title words.

For example: “Title Operations”>>“Title Supervisor”, “Sr. Escrow Officer”

Again referring to the example embodiment depicted in FIG. 1, a second deep neural network comprises a Character-level Convolutional Neural Network.

In the depicted embodiment, the character-level convolutional neural network better handles misspellings, abbreviations, and new words (even not seen during training).

For example: “Mfg Prod Spvr”>>“Production Supervisor”, “Production Manager, Manufacturing”

The predictions of the two sub-models are then combined by the two neural networks and dynamically transformed into a data set use to produce the most accurate matches by leveraging the different strengths of each model.

According to a still further embodiment, an automatic match based on high statistical correlation called an “automatch threshold” used to identify high-confidence matches. According a further embodiment still, additional machine-learning models are used to recommend matches for other compensable factors including years of experience, education, management role, skills & certifications, etc., to further expedite the benchmarking process.

Though the present invention has been depicted and described in detail above with respect to several exemplary embodiments, those of ordinary skill in the art will also appreciate that minor changes to the description, and various other modifications, omissions and additions may also be made without departing from either the spirit or scope thereof.

1. An automated business method, said method comprising: using two or more integrated neural networks to match education, salary and other predefined employment-related data.
